(19) United States
(12) Patent Application Publication
(10) Pub. No.: US 2013/0090117 A1
(43) Pub. Date: Apr. 11, 2013

(54) METHOD AND APPARATUS FOR OPTIMIZED REACQUISITION OF WIRELESS COMMUNICATIONS SYSTEMS

(71) Applicants: Francis Ming-Meng Ngai, Louisville, CO (US); Carlos Puig, Santa Clara, CA (US); Arvind Swaminathan, San Diego, CA (US)

(72) Inventors: Francis Ming-Meng Ngai, Louisville, CO (US); Carlos Puig, Santa Clara, CA (US); Arvind Swaminathan, San Diego, CA (US)

(73) Assignee: QUALCOMM INCORPORATED, San Diego, CA (US)

(21) Appl. No.: 13/563,582

(22) Filed: Jul. 31, 2012

Related U.S. Application Data
(60) Provisional application No. 61/544,041, filed on Oct. 6, 2011.

(51) Int. Cl. H04W 52/02; H04W 48/16

(52) U.S. Cl. 455/434; 455/574

(57) ABSTRACT

Motion status states reported by an advanced motion detection process or other means of obtaining a movement state of Stationary or Non-Stationary from filtered accelerometer data are utilized to reacquire service during Out of Service scenarios. Both movement states operate in three power phases: aggressive scanning or normal power mode, slow scanning or moderate power mode, and deep sleep or power saving mode. The scanning rate, power mode, scanning period and/or channel list depend upon the movement state and power phase. Motion information obtained from an advanced motion detection process provides substantial improvements in service reacquisition performance and power consumption in stationary Out of Service scenarios. When compared to traditional service reacquisition scanning routines, the reductions in average current can be achieved of: at a 5-minute OOS mark, ˜45% reduction, at a 15-minute OOS mark, ˜60% reduction and at a 6-hour OOS mark, ˜50% reduction.

### CLAIM OF PRIORITY UNDER 35 U.S.C. §119

The present Application for Patent claims priority to Provisional Application No. 61/544,041 entitled METHOD AND APPARATUS FOR OPTIMIZED REACQUISITION OF WIRELESS COMMUNICATIONS SYSTEMS filed Oct. 6, 2011, and assigned to the assignee hereof and hereby expressly incorporated by reference herein.

### REFERENCE TO CO-PENDING APPLICATIONS FOR PATENT

The present Application for Patent is related to the following co-pending U.S. Patent Applications “METHOD AND APPARATUS FOR ADVANCED MOTION DETECTION IN WIRELESS COMMUNICATION SYSTEMS” by Ngai et al., having Attorney Docket No. 111049U2, filed concurrently herewith, assigned to the assignee hereof, and expressly incorporated by reference herein.

### BACKGROUND

1. Field

The present invention relates generally to wireless communications, and more specifically to techniques for optimizing the reacquisition of wireless communications systems.

2. Background

Wireless communication systems are widely deployed to provide various types of communication and to communicate information regardless of where a user is located (e.g., inside or outside a structure) or whether a user is stationary or moving (e.g., in a vehicle, walking) For example, voice, data, video and so forth can be provided to mobile devices through wireless communication systems, sent both to and from the mobile devices. A typical wireless communication system, or network, can provide multiple users access to one or more shared resource(s). A system can use a variety of multiple access techniques such as Frequency Division Multiplexing (FDM), Time Division Multiplexing (TDM), Code Division Multiplexing (CDM), Orthogonal Frequency Division Multiplexing (OFDM), and others. These systems may comprise technologies such as 3rd Generation Partnership Project (3GPP) and 3rd Generation Partnership Project 2 (3GPP2) networks having W-CDMA (Wideband Code Division Multiple Access) air interfaces, Global System for Mobile Communications (GSM), or other network technologies such as Universal Mobile Telecommunication System (UMTS) Terrestrial Radio Access (UTRA). Mobile devices support Single carrier (1×) radio transmission technology, CDMA2000 EVDO, CDMA2000 1×RTT, GSM and WCDMA.

A mobile device goes Out of Service (OOS) when signal coverage is lost due to user movement, signal blockage, or other outages. OOS conditions necessitate a search for another available network in order for the mobile device to reacquire service. Traditional methods of service reacquisition waste processing resources and power, and delay the reacquisition of service because current scan algorithms and scan patterns simply repeatedly scan the same network provider list without considering whether the device is stationary or non-stationary, or accounting for other factors. Minimizing power consumption in mobile devices is important for all wireless communications systems. Mobile devices are increasingly consuming higher amounts of power as they become more and more sophisticated. Mobile devices have an onboard battery with a limited capacity. Thus, there is a problem of optimally reacquiring service under the constraint of a limited battery. There is therefore a need in the art to optimize service reacquisition in mobile devices while reducing the consumption of power, thereby maximizing each device's standby time.

### BRIEF DESCRIPTION OF THE DRAWINGS

FIG. 1 is a diagram illustrating an example of a wireless network in which Optimized Reacquisition of Wireless Communications Systems can be used;

FIG. 2 is an exemplary state diagram illustrating Optimized Reacquisition of Wireless Communications Systems operation;

FIG. 3 is an exemplary flowchart illustrating Optimized Reacquisition of Wireless Communications Systems methodology; and

FIG. 4 is a block diagram illustrating an exemplary wireless device capable of Optimized Reacquisition of Wireless Communications Systems.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The terms “mobile device”, “wireless device” and “user equipment” (UE) as used herein refer to and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a wireless local loop (WLL) station, a personal digital assistant (PDA), a laptop, a tablet, a handheld communication device, a handheld computing device, a satellite radio, a wireless modem card and/or another processing device for communicating over a wireless system. Moreover, various aspects are described herein in connection with a base station. A base station may be utilized for communicating with wireless terminal(s) and can also be called, and may contain some or all of the functionality of, an access point, node, Node B, e-NodeB, e-NB, or some other network entity.

Substantial improvements in wireless network service reacquisition performance and reduced power consumption in wireless devices are realized using motion information. Stationary and non-stationary states determine scanning patterns, power modes and sleep durations.

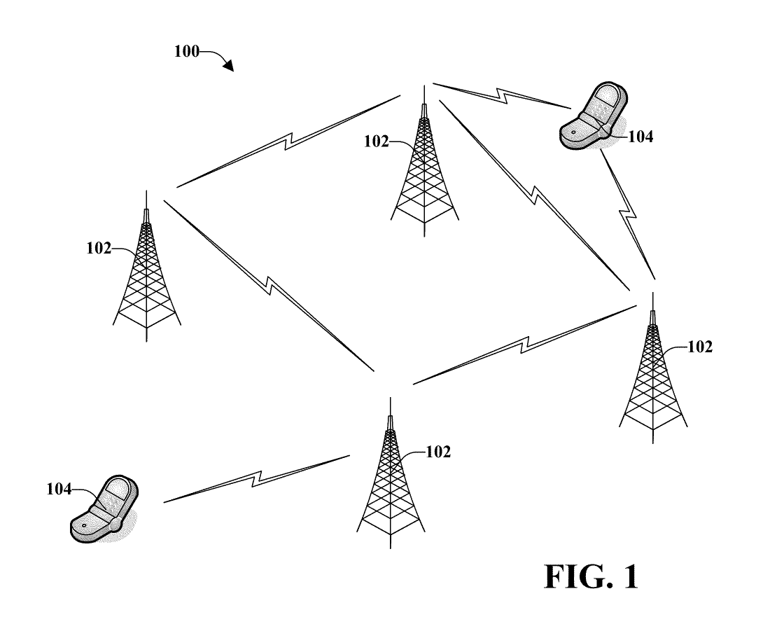

FIG. 1 illustrates a wireless communication system 100 in accordance with various aspects presented herein. System 100 can comprise one or more base stations 102 in one or more sectors that receive, transmit, repeat, or otherwise exchange wireless communication signals with each other and/or to one or more mobile devices 104. Each base station 102 can comprise multiple transmitter chains and receiver chains (e.g., one for each transmit and receive antenna), each of which can in turn comprise a plurality of components associated with signal transmission and reception (e.g., processors, modulators, multiplexers, demodulators, demultiplexers, antennas, and so forth). Each mobile device 104 can comprise one or more transmitter chains and receiver chains, which can be utilized for a multiple input multiple output (MIMO) system. Each transmitter and receiver chain can comprise a plurality of components associated with signal transmission and reception (e.g., processors, modulators, multiplexers, demodulators, demultiplexers, antennas, and so on), as will be appreciated by one skilled in the art. One or more base stations 102 can be associated with a home network or with a roaming network, depending on the communication environment.

Each mobile device 104 can be configured to maintain a history of the networks (e.g., base stations 102) it has acquired as well as other parameters (e.g., time of acquisition, time of loss of network, time of departing a network, time in service, network preference, frequency, channel of network, technology utilized by the network (e.g., GSM, 1×, wireless LAN, LTE, etc.), system id and network id, and so on). Based on this history, a channel scanning order (e.g., list, table, chart, and so forth) can be established such that more preferred networks (e.g., home network) are scanned first and other networks' channels (e.g., roaming networks) are scanned only if the preferred networks cannot be accessed. In order to conserve power, the channel scanning frequency is changed according to whether a mobile device is stationary or non-stationary during attempts to reacquire network service. In this situation, scanning is slowed according to a scanning algorithm having phases such as aggressive, moderate, or deep sleep. These various aspects are discussed in further detail below.

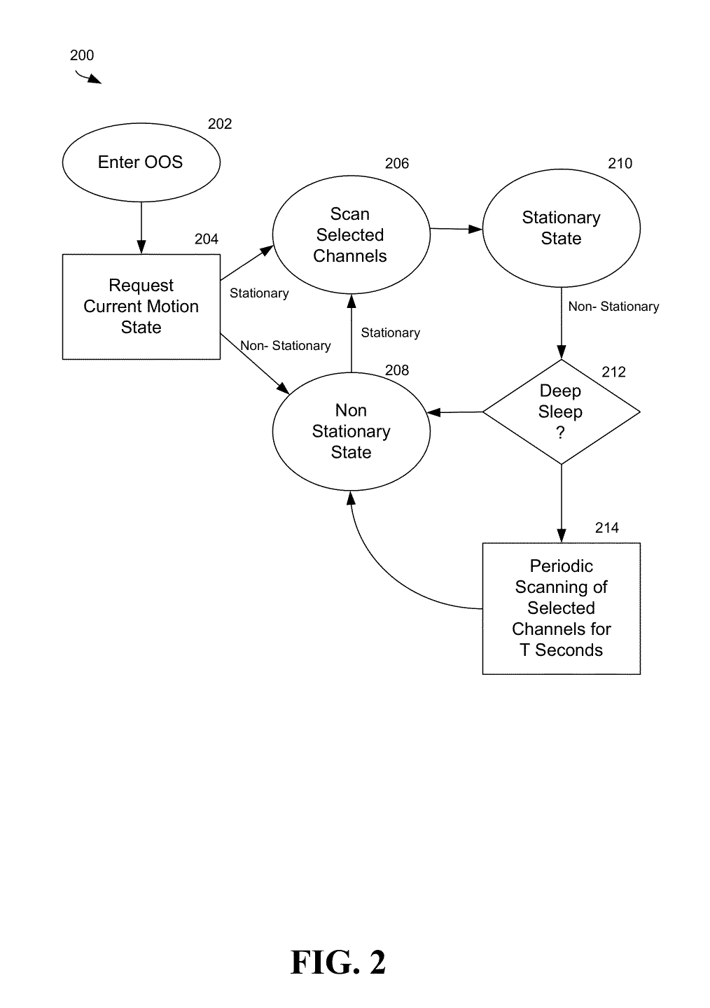

FIG. 2 is an exemplary state machine illustrating Optimized Reacquisition of Wireless Communications Systems operation 200. When a mobile device loses service, existing scan algorithms look for service using scan patterns that do not account for whether the mobile device is stationary or non-stationary. When traditional stationary mobile devices lose service, they continue motion independent scanning for 15 minutes until deep sleeping to save power regardless of whether the UE is stationary. For example, if a user is stationary (at a desk or otherwise) repeatedly scanning the same channels in the same spot can waste power for 15 minutes. The novel Optimized Reacquisition OOS scan algorithm detailed below achieves an optimum trade-off between power-consumption and reacquisition delay using motion status information states to determine service scanning rates.

Motion status is determined by an advanced sensor augmented implementation detailed in co-pending U.S. Patent Application METHOD AND APPARATUS FOR ADVANCED MOTION DETECTION IN WIRELESS COMMUNICATION SYSTEMS, having Attorney Docket No. 111049U2, filed concurrently herewith, assigned to the assignee hereof, and expressly incorporated by reference herein. This advanced motion status implementation processes accelerometer data to distinguish between random motion in place and actual start of motion that could lead to a change in the user's location. Random motion in place, such as table banging, knee jiggling, vibration, etc., is filtered from motion status determinations. The process utilizes data available from motion sensors or any accelerometer standard in all smart mobile devices and any mobile device that has automatic portrait-landscape switching (screen rotation). Filters for sustained motion are applied before changing movement states so that a movement state does not respond to un-sustained random motion. Motion status states are Moving state or At Rest state.

Within the advanced motion detection process, the motion status states are filtered to determine two Optimized Reacquisition OOS algorithm movement states, Stationary and Non-Stationary. Both Optimized Reacquisition OOS algorithm movement states may operate in a variety of scanning phases such as: aggressive scanning or normal power mode, slow scanning or moderate power mode, and deep sleep or low power (power saving) mode. The scanning rate depends upon the movement state and power phase of the Optimized Reacquisition OOS algorithm.

Even though a user is stationary, channel conditions may not be stationary. Thus, scanning while a user is stationary is performed at a slower rate but not stopped completely. For example, if a user is sitting in a café where the signal is blocked by a truck, the algorithm for Optimized Reacquisition of Wireless Communications Systems enters a slow scanning or moderate power mode performing slow scanning for 15 minutes and then sleeps for periods of 3 minutes before rescanning unless there is a key press to make a call, allowing the truck to pass or pull away while conserving power. Should the Out of Service condition not be remedied by a predetermined amount of time, e.g. 6 minutes, the mobile device may transition to a deep sleep power phase (i.e., lowest power saving phase). When movement resumes during the 3 minute power saving periods (quick peek periods) normal scanning, or aggressive scanning or normal power mode, resumes rather than delaying until the end of the period. In another example, if a service outage exists and the device is in long sleep or short awake duration mode while a user is sitting in meeting who then gets up and walks out, going from a stationary to non-stationary state, in one embodiment scanning resumes on a semi-aggressive/frequent scanning basis, e.g., for example for instance every one tenth of a second for the next two minutes. Because a newly non-stationary motion status does not guarantee immediate service availability, semi-aggressive scanning for a predetermined amount of time is performed. If the UE looks diligently for service for a brief time and no service can be obtained within this time window, then the UE resumes nominal awake duration, sleep duration, scan pattern and frequency for a non-stationary mode.

When transitioning from a non-stationary state to a stationary state, the Optimized Reacquisition OOS algorithm scans all provisioned systems once to ascertain that there is no usable system at that stationary spot at that time, and then starts to slow down the scanning rate. The slowed scanning rate is determined by the movement state and power mode. In a mode of short awake duration and long sleep duration, stationary to non-stationary transition wakes up a modem processor, which scans the channels in the periodic slow scanning moderate power mode in anticipation that the device can re-acquire service soon.

In one embodiment, the Optimized Reacquisition OOS algorithm is implemented on the modem processor and the advanced motion detection process is implemented on a Sensor Processing Sub-system (SPS). The SPS is a low power processor for processing accelerometer data and performing other sensor-related tasks, while conserving power. In the deep sleep power phase, the main processor or modem processor is not turned on to enable radio functions or scan for channels to do a scan unless the mobile device is moving in a sustained manner, which can be associated with a user's location change. In other embodiments, both the Reacquisition OOS algorithm and the advanced motion detection process can be implemented on the modem processor or another processor with attached accelerometer.

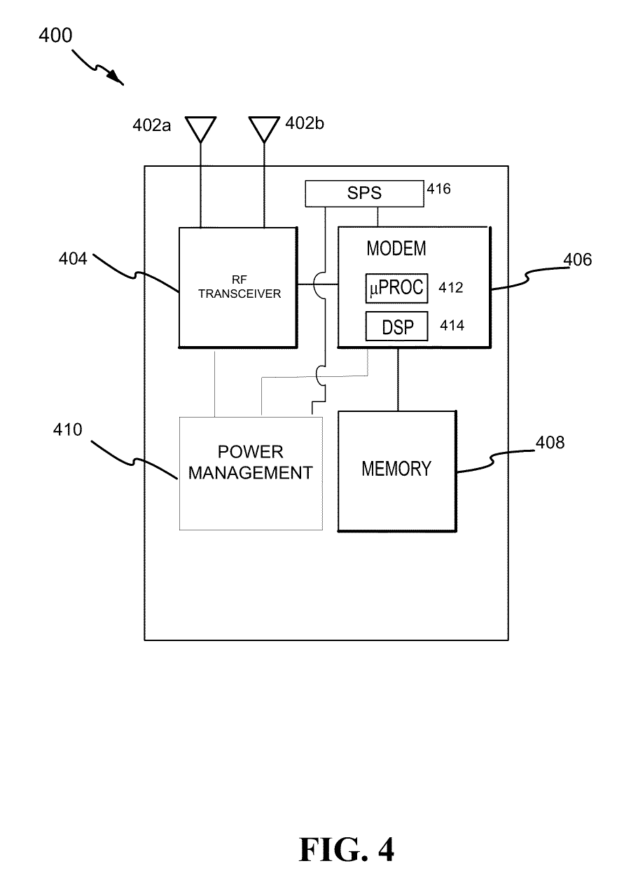

Optimized Reacquisition of Wireless Communications Systems operation begins with element 202 when a mobile device 104 enters an OOS condition. Next, a current movement state is requested from an advanced motion detection process operating on a SPS or other means of obtaining a movement state of Stationary or Non-Stationary from filtered accelerometer data 204. In some embodiments, the Optimized Reacquisition of Wireless Communications Systems algorithm may register with a separate process for obtaining a movement state. For instance, the modem processor (shown in FIG. 4) requests that the SPS (or other means) provide both (a) current movement state and (b) future notifications of any movement state change

If a Stationary movement state is returned, operation continues with scanning of selected channels for available service by element 206. When scanning completes, operation waits at Stationary movement state element 210 for further action until a Non-Stationary movement state report causes a transition to element 212. Note that scanning states may also be driven by a combination of time elapsed since OOS and movement state. FIG. 2 primarily depicts functionality pertaining to the movement state side. Within a movement state (Stationary or Non-stationary), scanning and sleeping are taking place based on time elapsed. However, operation may also be based on elapsed time such that scanning would continue in a Stationary state due to the fact that a channel could be changing or for instance, a truck may be blocking the signal.

If a Non-Stationary movement state is reported by the advanced motion detection process at element 204, operation waits at element 208 for further action until a Stationary movement state report causes a transition to element 206. For each Non-Stationary to Stationary movement state transition, the Optimized Reacquisition of Wireless Communications Systems algorithm will scan provisioned channels to ascertain there is indeed no usable system at that location at that time in element 206.

When a transition from a Stationary movement state to a Non-Stationary movement state causes Stationary movement state element 210 to transition to element 212, element 212 determines whether the mobile device 104 is currently in short awake duration or long sleep duration mode. If the mobile device is currently in a deep sleep power saving mode, operation continues with element 214 where a “quick peek” periodic scan of selected channels is performed for T seconds and operation returns to Non-Stationary movement state 208. Full scans on Most Recently Used (MRU) channels are performed, while micro-scans are performed on all other channels in order to save power. The most robust but potentially power hungry methods are invoked for the most promising channels, while methods that require less power, but potentially not the most robust, are invoked for less promising channels. For each Stationary to Non-Stationary movement state transition in deep sleep power saving mode, periodic scanning of selected channels for a fixed duration of time is invoked to increase the window of opportunity to re-acquire service. If the mobile device currently in a normal or moderate power mode, operation proceeds directly to Non-Stationary movement state 208.

In various embodiments, channel availability from previous episodes of OOS are utilized to determine scan patterns, frequencies and durations. A state of unsustainable service may be identified when, due to a noisy channel for example, a mobile device constantly loses and reacquires services. In cases of the UE being stationary and service is unsustainable, scanning all of the channels is immediately slowed. In other slowed scanning scenarios, scanning of all the channels is systematically slowed down further. Scanning is performed for 5 seconds between sleep states of 10 seconds, in preparation for provisioning deep sleep. Some channels will be scanned at a high rate while other channels will have their scanning rate reduced because they are unlikely to provide service. The channels that continue to be scanned frequently within the confines of an increased sleep duration are identified by MRU list. Concentric geographical areas (GEOS) may be used to prioritize searching. Other methods of prioritizing available service searches may comprise scanning channels with a high probability of providing service using coherent and non-coherent integration. Systems having a low probability of providing service and therefore a lower priority are scanned by measuring the received power for that channel. Scanning only proceeds to coherent and non-coherent integration if the in-band received power exceeds a certain threshold in order to conserve time resources. For lower priorities, instead of using the most robust method, a less robust method is employed that requires less resources, freeing up more time and resources to scan the channels that are the most promising.

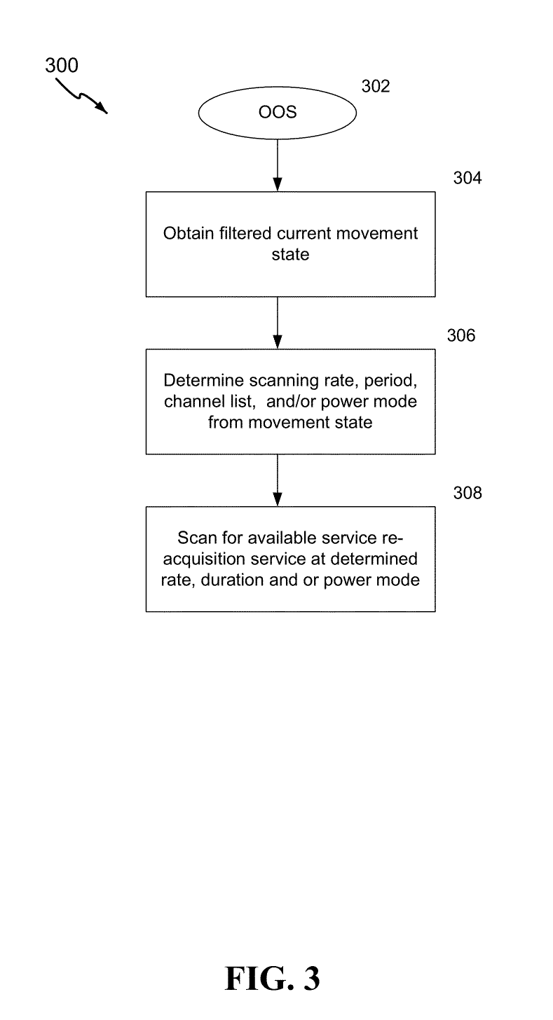

FIG. 3 is an exemplary flowchart illustrating Optimized Reacquisition of Wireless Communications Systems methodology 300. Control flow begins in step 302 when a mobile device experiences an OOS condition. Control flow proceeds to step 304.

In step 304, a current movement state is obtained from an advanced motion detection process or other means of obtaining a movement state of Stationary or Non-Stationary from filtered accelerometer data. Control flow proceeds to step 306.

In step 306, scanning rate, scanning period, a channel list, a power mode, and/or other scanning parameters are determined from the current movement state as detailed in FIG. 2. Control flow proceeds to step 308.

In step 308, scanning for available reacquisition service is performed using the parameters determined from the current movement state.

FIG. 4 is a block diagram illustrating an exemplary wireless device capable of Optimized Reacquisition of Wireless Communications Systems. Wireless device 400 comprises a wireless communication transceiver 404 and associated antennas 402a, 402b capable of sending and receiving wireless communication signals. Modem 406 comprises the appropriate microprocessor(s) 412, digital signal processor(s) 414 and other suitable hardware, such as a correlator bank, for processing signals. Power management 410 controls power for various components of wireless device 400. Memory 408 is coupled to modem 406 as necessary for implementing various modem processes. Wireless device 400 may comprise an appropriate user interface with alphanumeric keypad, display, microphone, speaker, and other necessary components (not shown). It will be appreciated by those skilled in the art that wireless device 400 may comprise a variety of components not shown.

The methodology for Optimized Reacquisition of Wireless Communications Systems described herein may be implemented by suitable instructions operating on the microprocessor 412, optionally the SPS 416 and memory 408 of wireless device 400, but is certainly not limited to such an implementation and may alternatively be implemented in hardware circuitry. The microprocessor 412 is connected to power management 410 and memory 408 having code or instructions directing the microprocessor 412 to perform Optimized Reacquisition of Wireless Communications Systems. Memory 408 may comprise instructions for performing Optimized Reacquisition of Wireless Communications Systems. The memory 408 may include RAM memory, flash memory, ROM memory, EPROM memory, EEPROM memory, registers, a hard disk, a removable disk, a CD-ROM, or any other form of storage medium or computer readable media known in the art. In an exemplary aspect, the control processor 412 executes instructions stored in memory 408 according to the steps of FIGS. 2-3 to perform Optimized Reacquisition of Wireless Communications Systems. An advanced motion detection process may operate independently on a low power SPS 416.

Thus, motion information obtained from an advanced motion detection process or other means of obtaining a movement state of Stationary or Non-Stationary from filtered accelerometer data provides substantial improvements in service reacquisition performance and power consumption in stationary OOS scenarios. Moving and At Rest motion status states are filtered via a state machine to provide transitions between the Stationary and Non-Stationary movement states. When compared to traditional service reacquisition scanning routines, the average current can be reduced significantly.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for reacquiring wireless communications service for a mobile device comprising:
obtaining a filtered current movement state;
determining a scanning rate, scanning period, channel list, and/or power mode from the current movement state; and
scanning for available reacquisition service using the determined scanning rate, scanning period, channel list, and/or power mode.

2. The method of claim 1 wherein the current movement state comprises a Stationary state.

3. The method of claim 1 wherein the current movement state comprises a Non-Stationary state.

4. The method of claim 1 wherein the mobile device is in an Unsustainable Service state.

5. The method of claim 1 wherein the filtered current movement state is obtained from an advanced motion detection process or other means of obtaining a movement state from filtered accelerometer data.

6. The method of claim 1 wherein the power mode comprises a normal power mode, a moderate power mode and/or a low power mode.

7. The method of claim 1 wherein the scanning rate comprises an aggressive scanning rate, a moderate scanning rate and/or a slow scanning rate.

8. The method of claim 7 wherein the channel scanning frequency is changed according to whether a mobile device is stationary or non-stationary.

9. The method of claim 1 wherein when transitioning from a current movement state of non-stationary to a current movement state of stationary state, all provisioned systems are scanned once to ascertain that there is no usable system at that stationary spot at that time, and then slows the scanning rate.

10. The method of claim 1 wherein the scanning rate is reduced in conjunction with a mobile device becoming stationary.

11. The method of claim 9 wherein at least one filter for sustained motion is applied before changing movement states so that movement state changes do not occur in response to un-sustained random motion.

12. The method of claim 1 wherein at a transition from a Stationary movement state to a Non-Stationary movement state during a low power mode, a “quick peek” periodic scan of selected channels is performed.

13. The method of claim 1 wherein scanning for available reacquisition service further comprises full scanning on Most Recently Used (MRU) and micro-scanning on all other channels.

14. A wireless device comprising:
a wireless communications transceiver and associated antenna(s) capable of sending and receiving wireless communications signals;
a modem coupled to the transceiver comprising processor(s) for processing signals and executing code stored in a memory;
a power management unit coupled to the modem and the transceiver for controlling power consumption; and
a memory coupled to the modem for storing instructions for obtaining a filtered current movement state, determining a scanning rate, scanning period, channel list, and/or power mode from the current movement state and scanning for available reacquisition service using the determined scanning rate, scanning period, channel list, and/or power mode.

15. The wireless device as recited in claim 14 which further includes a motion detector.

16. The wireless device as recited in claim 15 wherein said motion detector operates in conjunction with functions consisting of dead reckoning, motion type-identification, direction of motion and combinations thereof.

16. The wireless device of claim 14 wherein the current movement state comprises a Stationary state.

17. The wireless device of claim 14 wherein the current movement state comprises a Non-Stationary state.

18. The wireless device of claim 14 wherein the wireless device is in an Unsustainable Service state.

19. The wireless device of claim 14 wherein the filtered current movement state is obtained from an advanced motion detection process or other means of obtaining a movement state from filtered accelerometer data.

20. The wireless device of claim 14 wherein the power mode comprises a normal power mode, a moderate power mode and/or a low power mode.

21. The wireless device of claim 14 wherein the scanning rate comprises an aggressive scanning rate, a moderate scanning rate and/or a slow scanning rate.

22. The method of wireless device 14 wherein when transitioning from a current movement state of non-stationary to a current movement state of stationary state, all provisioned systems are scanned once to ascertain that there is no usable system at that stationary spot at that time, and then slows the scanning rate.

23. The wireless device of claim 14 wherein at a transition from a Stationary movement state to a Non-Stationary movement state during a low power mode, a “quick peek” periodic scan of selected channels is performed.

24. The wireless device of claim 14 wherein scanning for available reacquisition service further comprises full scanning on Most Recently Used (MRU) and micro-scanning on all other channels.

25. A computer readable medium having instructions stored thereon to cause a processor in a wireless device to:
obtain a filtered current movement state;
determine a scanning rate, scanning period, channel list, and/or power mode from the current movement state; and
scan for available reacquisition service using the determined scanning rate, scanning period, channel list, and/or power mode.

26. The computer readable medium of claim 25 wherein the current movement state comprises a Stationary state.

27. The computer readable medium of claim 25 wherein the current movement state comprises a Non-Stationary state.

28. The computer readable medium of claim 25 wherein the wireless device is in an Unsustainable Service state.

29. The computer readable medium of claim 25 wherein the filtered current movement state is obtained from an advanced motion detection process or other means of obtaining a movement state from filtered accelerometer data.

30. The computer readable medium of claim 25 wherein the power mode comprises a normal power mode, a moderate power mode and/or a low power mode.

31. The computer readable medium of claim 25 wherein the scanning rate comprises an aggressive scanning rate, a moderate scanning rate and/or a slow scanning rate.

32. The computer readable medium of claim 25 wherein when transitioning from a current movement state of non-stationary to a current movement state of stationary state, all provisioned systems are scanned once to ascertain that there is no usable system at that stationary spot at that time, and then slows the scanning rate.

33. The computer readable medium of claim 25 wherein at a transition from a Stationary movement state to a Non-Stationary movement state during a low power mode, a “quick peek” periodic scan of selected channels is performed.

34. The computer readable medium of claim 25 wherein scanning for available reacquisition service further comprises full scanning on Most Recently Used (MRU) and micro-scanning on all other channels.

35. A means for reacquiring wireless communications service comprising:
means for obtaining a filtered current movement state;
means for determining a scanning rate, scanning period, channel list, and/or power mode from the current movement state; and
means for scanning for available reacquisition service using the determined scanning rate, scanning period, channel list, and/or power mode.
